(19) United States
(12) Patent Application Publication
(10) Pub. No.: US 2021/0133444 A1
(43) Pub. Date: May 6, 2021

(54) WORK RECOGNITION APPARATUS

(71) Applicant: HITACHI, LTD., Tokyo (JP)

(72) Inventor: Takumi NITO, Tokyo (JP)

(73) Assignee: HITACHI, LTD., Tokyo (JP)

(21) Appl. No.: 17/080,109

(22) Filed: Oct. 26, 2020

(30) Foreign Application Priority Data
Nov. 5, 2019 (JP) 2019-200459

(51) Int. Cl. G06K 9/00; G06Q 10/06; G06T 7/80

(52) U.S. Cl. CPC G06K 9/00664; G06Q 10/063114; G06T 17/30; G06T 7/80; G06Q 10/0633

(57) ABSTRACT

A work recognition apparatus acquires a reference image including a work target from an input and output unit, estimates a first relative position of the work target and a camera from the reference image, converts a two-dimensional work region for the work target included in the reference image into a three-dimensional work region using template information, stores the three-dimensional work region in a storage apparatus as work model information, estimates a second relative position of the work target and the camera in a determination image acquired by the camera, calculates pixel coordinates indicating a two-dimensional work region in the determination image on the basis of the second relative position and the three-dimensional work region, and outputs the two-dimensional work region in the determination image indicated by the pixel coordinates that has been calculated, so as to be displayed by the input and output apparatus.

### BACKGROUND OF THE INVENTION

### 1. Field of the Invention

The present invention relates to a technology of recognizing work of a worker.

### 2. Description of the Related Art

In the field of assembly processing, workers are required to perform assembly processing of products according to prescribed standard operation. Since standard operation is defined as operation required to maintain the quality of the product, if a worker performs operation different from the standard operation (deviating operation), quality problems are more likely to occur in the product that is the work target at that time. Therefore, it is necessary to have a function of automatically detecting deviating operation from motion information of a worker acquired by using various sensors. When deviating operation has been detected, the quality can be ensured by, for example, performing a reinspection on the product that is the work target at that time or discarding the product itself.

There is a technology disclosed in JP 2009-205282 A as a method of automatically analyzing operation of a worker. In JP 2009-205282 A, feature data is calculated from a moving image, and the moving image is divided by finding a time-series change in the feature data, that is, a change in operation. Time-series feature data or a symbol string representing time-series feature data is acquired from the divided moving images, and operation is analyzed using them. This means that complicated operation is divided into pieces of simpler operation, and this has an advantage that even complicated operation can be analyzed.

### SUMMARY OF THE INVENTION

For work on a desk, if a camera is fixed and installed on the desk, it is possible to directly compare standard operation with operation to be determined. However, when working is for a large product such as a plant product or a vehicle, the camera may not be fixed to the product. Furthermore, a product may not be fixed at a predetermined position during work. Therefore, it is difficult to accurately match the relative position of a camera and a worker every time, and operation of the worker may be deviated on an image. In addition to operation of a worker, a relative position of a camera and a work target (product) on which work is performed is also important information regarding whether operation is deviating, so that it is also necessary to determine whether the work position is correct.

One form of a work recognition apparatus for solving the above problems acquires a reference image including a work target from an input and output unit, estimates a first relative position of the work target and a camera from the reference image, converts a two-dimensional work region for the work target included in the reference image into a three-dimensional work region using template information, stores the three-dimensional work region in a storage apparatus as work model information, estimates a second relative position of the work target and the camera in a determination image acquired by the camera, calculates pixel coordinates indicating a two-dimensional work region in the determination image on the basis of the second relative position and the three-dimensional work region, and outputs the two-dimensional work region in the determination image indicated by the pixel coordinates that has been calculated so as to be displayed by the input and output apparatus.

Even if the position of the camera, the relative position of the camera and the work target, or the relative position of the camera and the worker changes, it is possible to estimate an appropriate work region on an image. Furthermore, it is possible to determine work operation of the worker.

### BRIEF DESCRIPTION OF THE DRAWINGS

FIG. 1 is a system configuration diagram according to an embodiment;

FIG. 2A is a hardware block diagram of an image processing apparatus according to the embodiment;

FIG. 2B is a diagram illustrating various programs stored in a storage apparatus according to the embodiment;

FIG. 3 is an explanatory diagram of conversion operation of a two-dimensional work region on an image into a three-dimensional work region according to the embodiment;

FIG. 4 is a diagram illustrating an example of a work region template according to the embodiment;

FIG. 5 is a diagram illustrating an overall processing flowchart according to the embodiment;

FIG. 6 is a diagram illustrating a camera parameter estimation flowchart according to the embodiment;

FIG. 7 is a diagram illustrating a work flow creation flowchart according to the embodiment;

FIG. 8 is a diagram illustrating an example of a work region according to the embodiment;

FIG. 9 is a diagram illustrating an example of a work region estimation image according to the embodiment;

FIG. 10A is a diagram illustrating an example of work model information according to the embodiment;

FIG. 10B is a diagram illustrating an example of work flow information according to the embodiment; and

FIG. 11 is a diagram illustrating an example of a work recognition flowchart according to the embodiment.

### DESCRIPTION OF THE PREFERRED EMBODIMENTS

### Embodiment

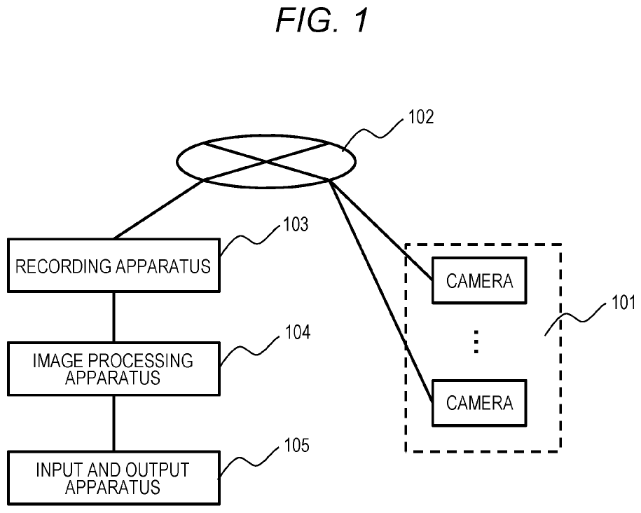

FIG. 1 is a system configuration diagram according to an embodiment.

An image captured by one or a plurality of cameras 101 is transmitted to a recording apparatus 103 via a network 102. The recording apparatus 103 accumulates images captured by the camera 101. The network 102 may be a wired network or a wireless network connected via a wireless access point. An image processing apparatus 104 uses the images accumulated in the recording apparatus 103 to recognize operation of a worker shown in a moving image, and displays the result on an input and output apparatus 105. Note that the recording apparatus 103, the image processing apparatus 104, and the input and output apparatus 105 may be integrated as a single computer.

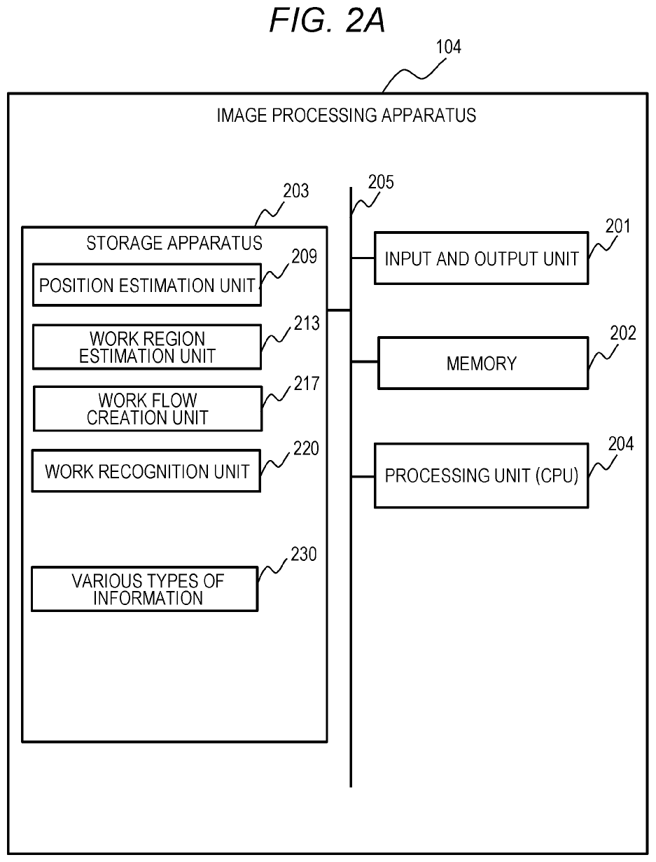

FIG. 2A is a hardware block diagram of the image processing apparatus 104 according to the embodiment. The image processing apparatus 104 is a computer including an input and output unit 201, a memory 202, a storage apparatus 203, and a processing unit (hereinafter, CPU) 204. The input and output unit 201, the memory 202, the storage apparatus 203, and the CPU 204 are connected via a bus 205.

The input and output unit 201 is an interface for connecting to the recording apparatus 103 and the input and output apparatus 105 in order to transmit and receive data to and from external devices of the recording apparatus 103 and the input and output apparatus 105, and includes, for example, a network interface card (NIC).

The memory 202 stores programs stored in the storage apparatus 203 and data to be processed by the processing unit 204. The memory 202 includes, for example, DRAM or SDRAM. The memory 202 also stores image data input from the recording apparatus 103 as an image memory. The image memory may be configured by a memory different from the memory 202.

The storage apparatus 203 includes HDD, SSD or the like which is a non-volatile storage medium, and stores a position estimation program, a work region estimation program, a work flow creation program, and a work recognition program. These programs are stored in the memory 202 and are executed by the CPU 204 to achieve various functions. In the description below, for easy understanding of the description, functions achieved by the CPU 204 executing the position estimation program, the work region estimation program, the work flow creation program, and the work recognition program are referred to as a position estimation unit 209, a work region estimation unit 213, a work flow creation unit 217, and a work recognition unit 220.

The storage apparatus 203 stores various types of information 230 such as camera parameters storing a focal length, an aspect ratio, an optical center and the like of the camera. Details of the various types of information 230 will be described with reference to FIG. 2B and the like.

FIG. 2B is a diagram for explaining details of the various programs and the various types of information 230 stored in the storage apparatus 203.

The storage apparatus 203 stores the various types of information 230. The various types of information 230 include information including: camera parameters 231 managing a focal length, an aspect ratio, an optical center and the like of a camera; work target data 232 managing a shape of a work target such as a product, 3D data, product feature point position and the like; work target position data 233 storing a positional relationship (relative position) of the camera and the work target; work region data 234 storing a work region of the worker; work model information 235 storing a work position, a work feature amount and the like of each piece of work performed by the worker; work flow information 236 storing the order of work, contents of each piece of work and the like; and work progress data 237 storing progress of work.

The position estimation unit 209 includes a camera parameter estimation unit 210 that estimates the camera parameters from a captured image of a calibration pattern, and stores the camera parameters as the camera parameters 231, and a work target position estimation unit 211 that estimates a positional relationship (relative position) of the work target and the camera from the captured image, and stores the positional relationship as the work target position data 233.

The work flow creation unit 217 includes a work region setting unit 218, a work model setting unit 219, and a work flow setting unit 225.

The work region setting unit 218 estimates a three-dimensional position of the two-dimensional region set by the user in a reference image obtained by capturing a situation where the worker is working on the work target, and stores the three-dimensional position as the work region data 234. The work model setting unit 219 creates a work model from the image and the work region designated by the user in the reference image, and stores the work model as the work model information 235. The work flow setting unit 225 creates a work flow from a flow of work designated by the user and stores the work flow as the work flow information 236.

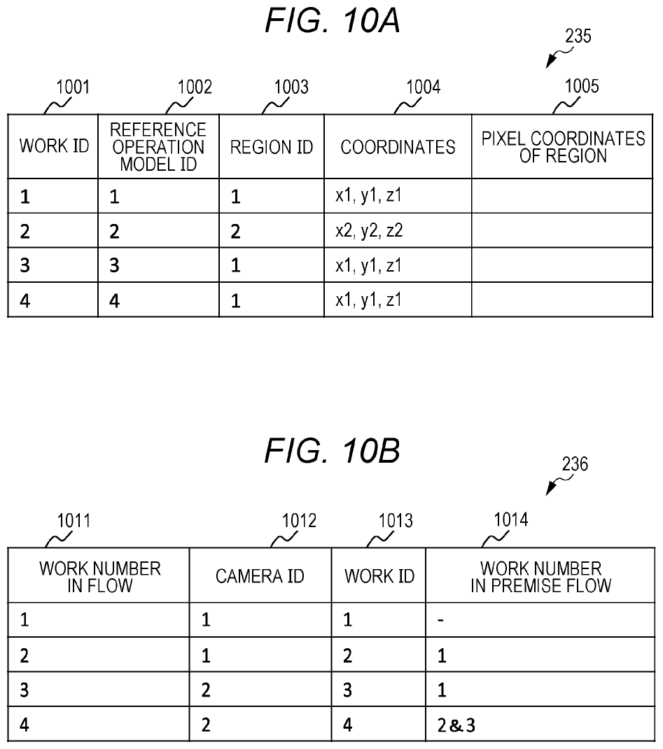

Here, the work model is a model in which the work of the worker is represented by a position of the work region and an operation model. The operation model represents information on a position of the hand or joint and motion of the hand or joint of the worker as time series information of the motion vector on the image or its representative value. The operation model may be time-series information regarding the relative position between the joints of the worker or a representative value thereof. The operation model may be represented as a probability distribution regarding them. When the operation model is represented as a probability distribution, a method of representing the operation model as a Gaussian distribution or a Gaussian mixture distribution that is a parametric representation method, a method of using a frequency distribution that is a nonparametric representation method, or a method using a Parzen window can be used. The worker's hand or joint position can be detected by attaching a color marker to the worker's hand or joint position at the time of image capturing, and detecting the position from the image using color detection. The work model information will be described later with reference to FIG. 10A.

The work region estimation unit 213 includes a work region three-dimensional position estimation unit 214 and a work region adjustment unit 215. The work region three-dimensional position estimation unit 214 estimates the three-dimensional position of the work region (three-dimensional work region) from the region designated in the image captured during the determination (determination image) and the two-dimensional work region designated by the user. The work region adjustment unit 215 sets the position of the two-dimensional work region of the determination image from the work target position data 233 and the work region data 234.

The work recognition unit 220 includes a work division unit 221, a work model selection unit 222, a work determination unit 223, and a work determination result output unit 224. The work division unit 221 divides motion of the worker shown in the captured moving image into pieces of work. The work model selection unit 222 determines which work the divided work corresponds to. The work determination unit 223 collates the determined work with the work flow to determine whether the flow of work is correct. The work determination result output unit 224 displays the result of the determination made by the work determination unit 223 on the input and output apparatus 105 having a display device via the input and output unit 201.

An example of work recognition using the configurations of FIGS. 1, 2A, and 2B will be described. It is desirable to arrange the camera 101 at a position where the worker's hand can perform capturing in each pieces of work. The camera 101 is assumed to be a commercially available network camera. Each camera has an identification information ID for identifying each camera. Each camera has an internal clock, and the pieces of time of the internal clocks are synchronized in advance using NTP or the like to be the same. The image captured by each camera is acquired by the recording apparatus 103 via the network 102 and recorded together with the identification information ID for identifying each camera and the capturing time.

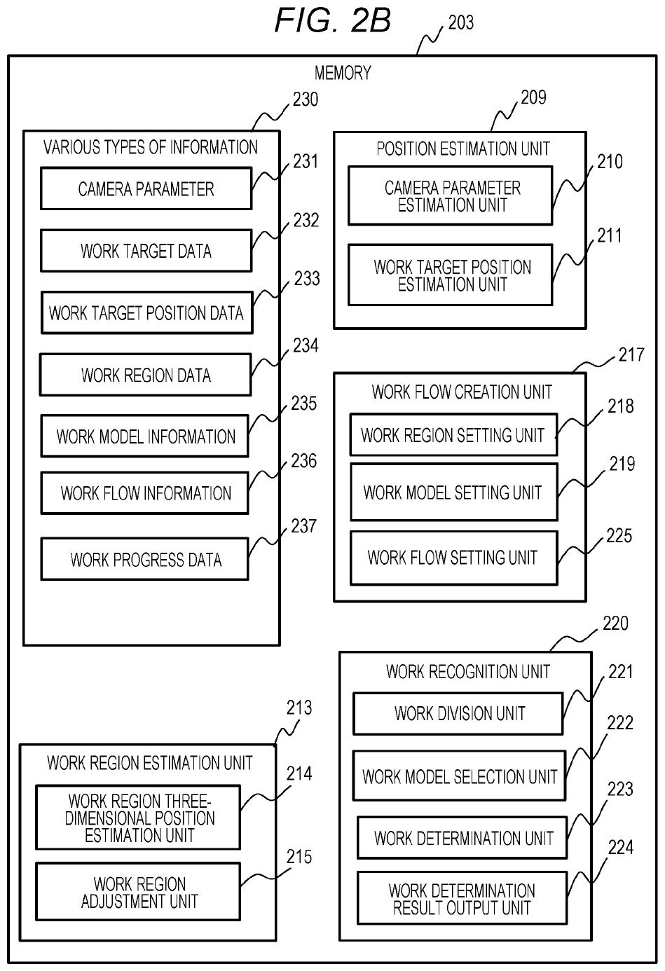

FIG. 3 is an explanatory diagram of conversion operation of a two-dimensional work region on an image into a three-dimensional work region according to the embodiment. The left side of FIG. 3 shows a state in which a product 303 that is the work target is on a work table 304, and the user has designated a work region 302 for the work target 303 on a screen 301. The right side of FIG. 3 shows a state in which a product 313 that is a work target is on a work table 314, and shows a three-dimensional work region calculated from the work region 302 designated in the left side of FIG. 3, that is, a three-dimensional position 312 of the work region. The work table 304 and the work table 314 are the same work table, and the product 303 and the product 313 are the same product.

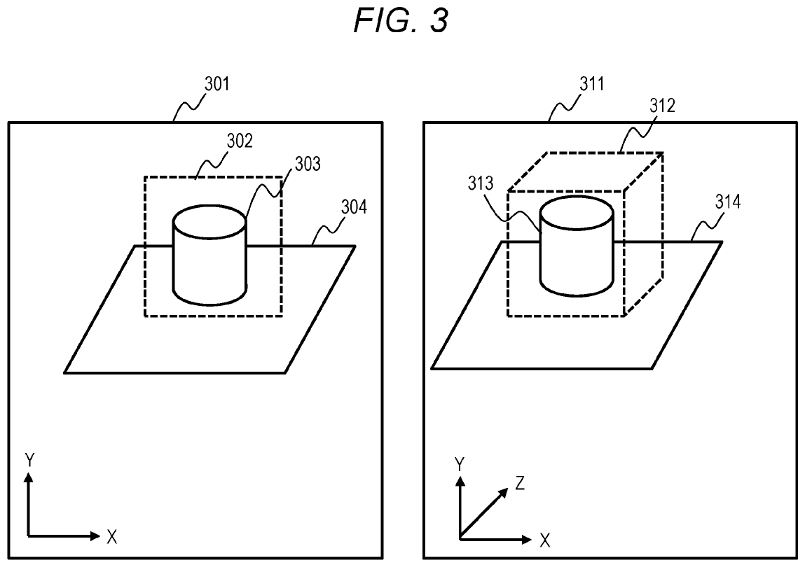

The work region setting unit 218 estimates a three-dimensional position 312 of a work region from the two-dimensional work region 302 set by the user, with respect to the work target, on an image, which is a reference image, obtained by capturing a situation where the worker is working, and stores the three-dimensional position 312 as the work region data 234. The two-dimensional work region 302 set by the user on the screen 301 captured on the image is converted into the three-dimensional work region 312 by using template information 400 (see FIG. 4). The work region three-dimensional position estimation unit 214 corresponds to processing of converting a two-dimensional work region designated by the user on the determination screen into a three-dimensional work region when the worker performs work on the work target in the determination image, and this corresponds to processing by the work region setting unit 218 of converting a two-dimensional work region into a three-dimensional work region by using a reference image. Although the images to be processed are different, the basic operation of conversion processing is the same.

FIG. 4 is a diagram illustrating an example of the template information 400, which is one of the various types of information 230.

In the template information 400, the two-dimensional work region 302 on the screen is used to estimate the position of the three-dimensional work region 312 by the work region setting unit 218.

In the template information 400, as information indicating a work region corresponding to a work target, an ID 401 that is information for identifying each template, and a shape 402 indicating the shape of the work region, and a size 403 of the work region, a positional relationship with an object serving as a reference for the position of the work, for example, a relationship 404 between the work region and the work table, and the like that are identified by the ID 401 are managed in a corresponding manner.

For example, the shape 402 of “cuboid”, the size 403 of “x1, y1, z1”, and the relationship 404 with the work table of “bottom surface contacts top of work table” are managed in the template with ID 401 “1”. The work region setting unit 218 uses this template to estimate the three-dimensional work region from the two-dimensional work region designated by the user on the screen.

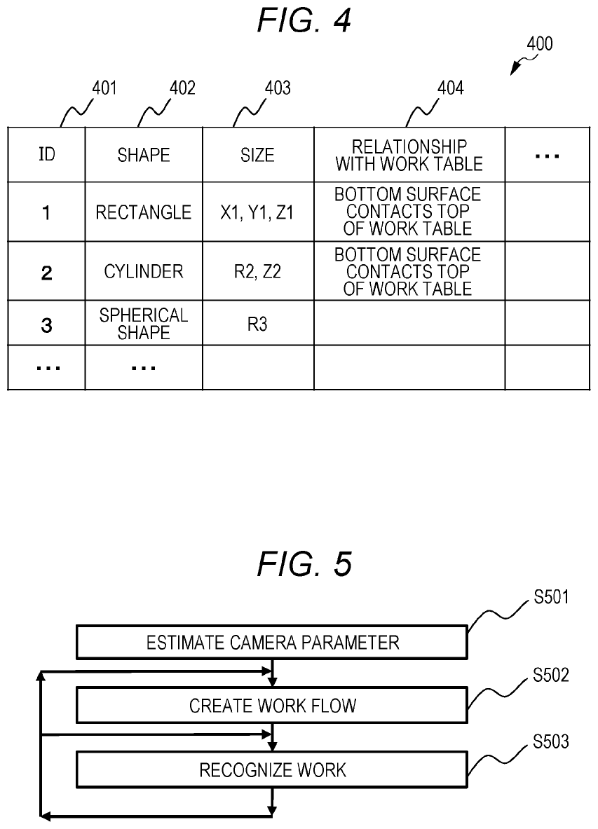

FIG. 5 is a diagram illustrating an overall processing flowchart according to the embodiment.

As preparatory steps, there are camera parameter estimation (S501), work flow creation (S502), and work recognition (S503) for actually making a determination. The work recognition (S503) is repeatedly performed for each work flow, and when defining a new work flow, the work flow creation (S502) is performed again. Each of the details is described below.

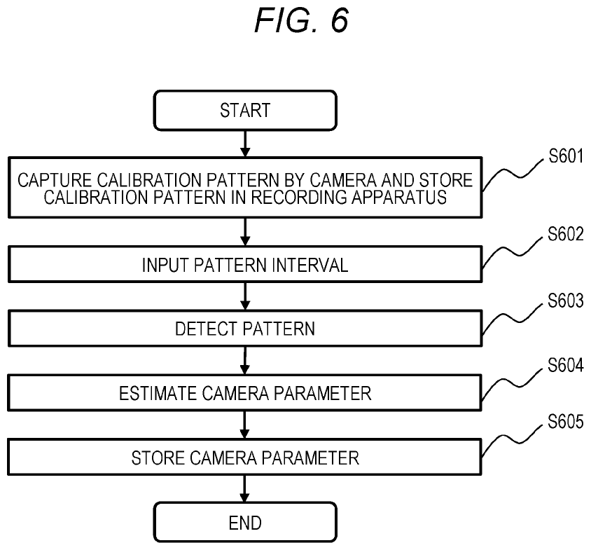

FIG. 6 is a diagram illustrating a processing flow of camera parameter estimation (S601) by the camera parameter estimation unit 210. FIG. 6 illustrates the flow of processing in the case of one camera. In the case of multiple cameras, the same processing is performed for each camera.

As for the flow of calibration processing, first, an image of a calibration pattern is captured by the camera 101, and is stored in the recording apparatus (S601). A plurality of calibration patterns such as checker patterns and dot patterns are captured by the camera 101, and the captured images are acquired and stored by the recording apparatus 103 via the network 102. Then, the input and output unit 201 reads the corresponding image from the recording apparatus 103 and stores the corresponding image in the memory 202. The number of images to be captured is about ten or more, and it is desirable that the position of the calibration pattern is such that the pattern appears at various positions on the image.

Next, the length of the calibration pattern interval is input to the camera parameter estimation unit 210 (S602). The information regarding the length of the calibration pattern interval may be information specifying the type of calibration input from the input and output unit 201. The information specifying the type of calibration input from the input and output unit 201 is information specifying the type of calibration captured by the camera 101.

Then, the camera parameter estimation unit 210 reads the image from the memory 202 storing the image showing the calibration pattern captured by the camera 101, and detects the pattern (S603). The pattern may be detected using a library such as OpenCV, https://opencv.org/.

Then, the camera parameter estimation unit 210 uses the pattern interval input from the input and output unit 201 and the pattern detected in step S403 to estimate the camera parameters (S604), and stores the camera parameter in the camera parameter 231 together with a camera ID (S605).

For the parameter estimation, for example, a method disclosed in Zhengyou Zhang, “Flexible Camera Calibration By Viewing a Plane From Unknown Orientations”, International Conference on Computer Vision, 1999 may be used. A similar method is also implemented in OpenCV, https://opencv.org/.

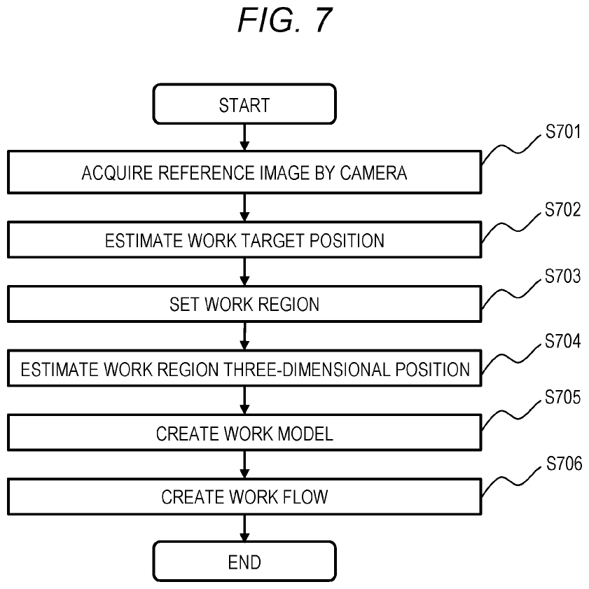

FIG. 7 is a diagram illustrating a flowchart of work flow creation performed by the position estimation unit 209 and the work flow creation unit 217 according to the embodiment.

First, the position estimation unit 209 (work target position estimation unit 211) acquires a reference image used as a reference for work determination captured by the camera 101 (S701). The reference image captured by the camera 101 is stored in the recording apparatus 103 via the network 102, and the image processing apparatus 104 acquires the stored reference image. Then, in the image processing apparatus 104, the input and output unit 201 reads the corresponding image from the recording apparatus 103 and stores the corresponding image in the memory 202.

Next, the work target position estimation unit 211 estimates the work target (product) position of the captured reference image (S702). The work target position estimation unit 211 estimates a positional relationship (first relative position) between the work target and the camera on the basis of the work target data such as the shape of the work target and the camera parameters, and stores the positional relationship in the work target position data 233.

In the positional relationship estimation by the work target position estimation unit 211, for example, a plurality of markers are attached to the work target when capturing a reference image, and a relative positional relationship between the plurality of markers and a 3D model of the work target are input as a work target data to detect pixel coordinates of the markers on the image. By solving the PnP problem using the camera parameters from the relative positional relationship of the input markers, it is possible to estimate the posture of the work target, and estimate the relative position of the camera and the work target. The obtained relative position is stored in the work target position data 233. The solving of the PnP problem is implemented in OpenCV, https://opencv.org/. By step S702, the relative position between the camera 101 and the work target when the reference image is captured is grasped.

Next, the work region setting unit 218 sets a work region (S703). Specifically, the work region setting unit 218 sets the two-dimensional work region input by the user from the input and output unit 201 on the reference screen. The work region is a region of an image in which work is performed in the reference image, and is represented by a region of pixel coordinates of the image.

In order to set the three-dimensional work region, the work region setting unit 218 estimates the three-dimensional position of the two-dimensional work region data input in the reference image (S704). In this estimation, as illustrated in FIG. 3, for example, the two-dimensional work region 302 of the reference image is converted into the work region 312 indicated by the three-dimensional position by using the template information. Note that the work region setting unit 218 calculates the pixel position on the image of the distance range from each point of the surface of the work target to the work target from the work target data 232 such as the work target 3D model stored as the work target data 232, the camera parameters 231, and the positional relationship between the camera and the work target and the distance range from the work target to the work region that are stored in the work target position data 233.

By looking at the overlap with the work region set by the user on the image, calculation is performed as to from which portion of the surface of the work target the work region is in the distance range. The calculation result is stored as work region data 234 as a three-dimensional relative position from the work target. The three-dimensional relative position between the work target and the work region stored as the work region data 234 has the same value for the same work for the same work target.

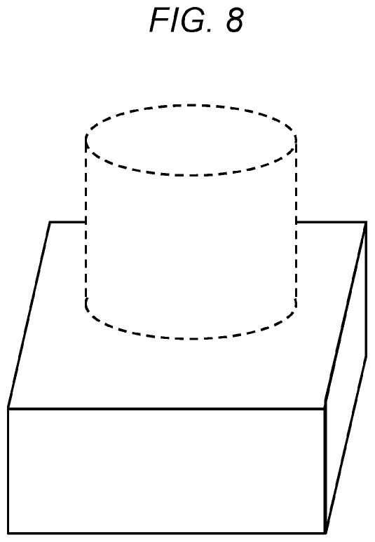

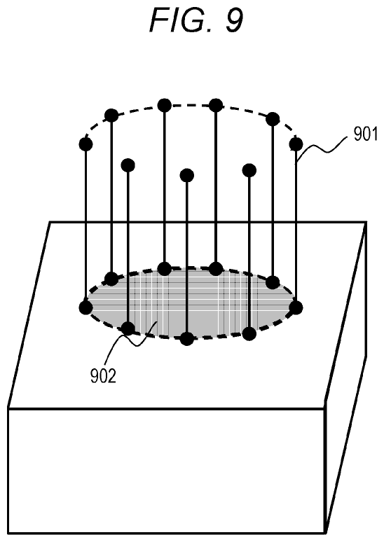

The three-dimensional position estimation of the work region illustrated in FIGS. 8 and 9 is another example of the estimation of the three-dimensional position of the work region illustrated in FIG. 3. FIG. 8 is a diagram illustrating an example of a work region according to the embodiment. The solid line in FIG. 8 is the work target, and the dotted line is the work region on the image. FIG. 9 is a diagram illustrating an example of a work region estimation image according to the embodiment. A line 901 with dots at both ends in FIG. 9 indicates a portion included in the work region on the image, in a straight line of a designated distance from each point on the work target surface, and a colored portion 902 is a portion corresponding to the target surface of the work region.

In the estimation of the three-dimensional position of the work region of the present embodiment, a columnar shape model in which the work region is at a designated distance from the surface of the work target is used. In addition, shape models of a spherical shape, a hemispherical shape, and a rectangular parallelepiped shape having a size designated from the designated point of the work target, and a fan-shaped column shape having a designated angle in the horizontal direction from the designated point of the work target are conceivable.

Next, the work model setting unit 219 of the work flow creation unit 217 creates a work model (S705). The work model is represented by the position of the work region and the operation model (reference operation model). The operation model represents motion information of a position of the hand or joint of the worker as time series information of the motion vector on the image or its representative value. The operation model may be time-series information regarding the relative position between the joints of the worker or a representative value thereof. The operation model may be represented as a probability distribution regarding them. When the operation model is represented as a probability distribution, a method of representing the operation model as a Gaussian distribution or a Gaussian mixture distribution that is a parametric representation method, a method of using a frequency distribution that is a nonparametric representation method, or a method using a Parzen window can be used. The hand or joint position of the worker is detected by attaching color markers to the hand or joint position of the worker at the time of capturing, and using color detection from the image, or using the method disclosed in “Zhe Cao, “Realtime Multi-Person 2D Pose Estimation using Part Affinity Fields”, IEEE Conference on Computer Vision and Pattern Recognition, 2017″ from the image. The position of the work region is specified by a region ID or the like.

The work model setting unit 219 stores, as work model information 235, the reference operation model calculated from the three-dimensional work region position calculated by the work region setting unit 218 and the reference image.

The work model created in steps (S701) to (S705) is performed for each type of work, and an ID is assigned to each type of work. The created work model is stored as the work model information 235 together with the work ID.

FIG. 10A illustrates an example of the work model information 235. FIG. 10B is a diagram illustrating an example of work flow information according to the embodiment. In the work model information 235, a work ID 1001 specifying the work of the worker, a reference operation model ID 1002 identifying the reference operation model of the work specified by the work ID, a region ID 1003 specifying the work region of the work specified by the work ID, and coordinate information 1004 indicating a three-dimensional position specified by the region ID are managed. Information on the camera ID may be added to the work model information 235.

Note that pixel coordinates 1005 of the region are blank in the work model created in steps (S701) to (S705).

In creating a work flow (S706), the user inputs the work flow in a format such as the table of FIG. 10B, and the work flow setting unit 225 stores the work flow in the work flow information 236 via the input and output unit 201. The storage apparatus 203 includes a work number 1011 indicating work in the work flow, a camera ID 1012 identifying a camera for capturing the work indicated by the work number, a work ID 1013 specifying the work of the work number, and a work number in premise flow 1014 indicating the work on which work completion before the work indicated by the work number is performed is premised.

In the example of FIG. 10B, the work flow is composed of four pieces of work, and for the work number in flow “1”, determination is made by the image of the camera ID “1”, the work ID is “1”, there is no premised work, and work can be performed from the beginning. For the work number in flow “2”, determination is made by the image of the camera ID “1”, the work ID is “2”, the premised work number in flow is “1”, and work can be performed after completion of the work number in flow “1”. This is similar for the work number in flow “3” and “4”, and designation of two work number in flow “2” and “3” for the work number in flow “4” indicates that the work can be performed after both the work number in flow “2” and “3” are completed.

Since the correspondence between the camera ID and the work ID is managed in FIG. 10B, the work model information 235 illustrated in FIG. 10A does not necessarily require the camera ID, but the work model information 235 may include the camera ID for management.

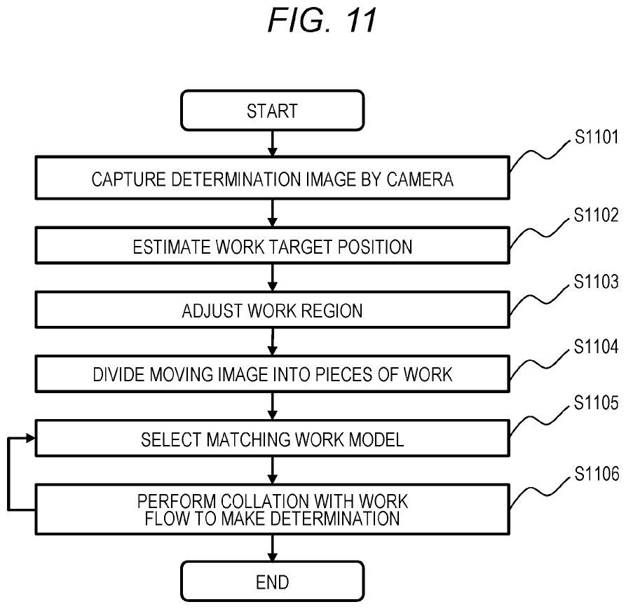

The flow of the work recognition (S503) processing performed by the work recognition unit 220 will be described with reference to the flowchart of FIG. 11.

First, a determination image is captured by the camera 101 (S1101). The recording apparatus 103 acquires a moving image captured by the camera via the network 102 and stores the moving image together with a camera ID and a time stamp. The input and output unit 201 acquires the stored image and stores the image in the memory 202.

Next, the work target position estimation unit 211 estimates the position of the work target such as a product shown in the determination image (S1102). This is performed by the same method as the estimation of the work target position in step S702, and the positional relationship (second relative position) between the work target and the camera is stored as the work target position data 233. If there are multiple cameras to be used for determination, the work target position is estimated for each camera, and the work target position data is stored together with the camera ID.

Next, the work region is adjusted (S1103). In adjusting the work region, even though the camera ID, work ID, and region ID are the same when the reference image is captured, and when the judgment image is captured, the camera and work target cannot be installed in the exact same position in some cases, and therefore, the relative positions of the camera and the work target may not always match. That is, the region of the pixel coordinates of the work region on the image set by the reference image cannot be used at the time of determination. Therefore, the work region three-dimensional position estimation unit 214 once performs the same processing as step S704 on the determination image to estimate the three-dimensional relative position of the work region with respect to the work target. Pixel coordinates of the work region on the image at the time of determination are calculated according to the positional relationship between the camera and the work target at the time of determination. The work region adjustment unit 215 outputs the two-dimensional work region in the determination image indicated by the calculated pixel coordinates so that the input and output apparatus 105 displays the two-dimensional work region.

A camera ID and a work ID are defined for each work number in flow of the work flow information 236. The work model indicated by the work ID 1001 of the work model information 235 has coordinate information 1004, which is the three-dimensional relative position of the work region with respect to the work target. In step S1102, the relative position between the camera that has captured the determination image at the time of determination and the work target is determined. In step S703, since the three-dimensional positional relationship between the work target and the work region in the reference image is obtained, the region of pixel coordinates on the image (two-dimensional) of the work region at the time of determination is calculated on the basis of the three-dimensional positional relationship between the work target and the work region in the reference image, the relative position between the camera and the work region and the camera parameters obtained in step S1102. When there are a plurality of cameras, the region of pixel coordinates of the region calculated for each camera ID is added to the work model information 235.

When the calculated pixel coordinates 1005 of the region is added to the work model information 235 of FIG. 10A, a work ID may be specified by a user and pixel coordinates 1005 may be added to the specified work ID. When the work ID is not input by the user, the work region corresponding to the region ID of the reference image corresponding to the camera ID that has been used for acquiring the determination image is displayed by the input and output apparatus 105 so as to be superimposed on the determination image, and the pixel coordinates of the calculated region are added to the region with a large amount of overlap. When there are a plurality of regions with a large amount of overlap, the pixel coordinates of the calculated regions are added to the plurality of region IDs 1003 (work model information 235). As described later, a configuration may be adopted in which the pixel coordinates of the regions calculated for all region IDs are stored, the work model of the worker in the determination image is compared with the reference operation model, only the pixel coordinate values for the region ID corresponding to the matching reference operation model are left, and the pixel coordinate values input to other regions ID are deleted.

As described above, in the present embodiment, the reference image is used to obtain the relative position of the work target and the camera, the two-dimensional work region in the reference image is designated, and the template information is used to obtain the three-dimensional work region. Regarding the work target and the three-dimensional work region, in the case of the same work for the same work target, the three-dimensional work region can be uniformly determined with respect to the work target data. That is, the three-dimensional work region is obtained for the same work target, for each work ID.

If the work region in the image at the time of determination can be associated with the work region of the reference image, the region of pixel coordinates on the image (two-dimensional) of the work region at the time of determination can be calculated. Needless to say, camera parameters are used when obtaining the three-dimensional work region from the two-dimensional work region in the reference image.

As described above, the reference image including the work target is acquired, the first relative position of the work target and the camera is estimated from the reference image, the two-dimensional work region for the work target included in the reference image is converted into a three-dimensional work using the template information, and stored in the storage apparatus as work model information. At the time of operation determination, the second relative position of the work target and the camera is estimated again in the determination image, and pixel coordinates indicating the two-dimensional work region in the determination image is calculated on the basis of the second relative position and the three-dimensional work region calculated by using the reference image.

Next, the work division unit 221 divides the moving image for each piece of work (S1104). The division can be performed by using a method of dividing by using a change in operation like the method of OpenCV, https://opencv.org/, or a method of dividing by obtaining work break information like the method of JP 2017-156978 A from a production apparatus. The detection of the position of the hand and joint is the same as the method in step S705. Then, each divided piece of work is determined along the time.

The work model selection unit 222 selects a work model that matches each piece of work (S1105). The camera ID indicating each piece of work, the position of the hand or joint, and the reference operation model obtained in the same manner as in step S705 are compared with the determination operation model of the determination image. Here, the pixel coordinates of the work region for each camera ID obtained in step S1103 can be referred to. Determination is made on which work model the work matches or the work does not match. The reference operation model to be compared is the reference operation model 1002 in FIG. 10A.

In this determination, the degree of matching of the position of the hand or joint and the work region is defined as the ratio of the time during which the position of the hand or joint is included in the work region. As a method of calculating the degree of matching between the operation models, the dynamic programming method can be used if the selected operation model is represented by time series information, and the Euclidean distance can be used if the selected operation model is represented by the representative value. If the operation model is represented as a probability distribution, when the probability distribution is a Gaussian distribution, the Mahalanobis distance can be used, and when the probability distribution is represented as another probability distribution, the degree of matching can be calculated by calculating the probability that divided pieces of analysis information occur. Even when the operation model is represented by a hidden Markov model, the probability that the divided pieces of analysis information can occur can be calculated, and the degree of matching can be calculated.

The work model selection unit 222 selects a work model in which the degree of matching of the positions and the operation model is equal to or greater than a threshold and is the highest. By selecting the work model, the work ID 1001, the reference operation model 1002, the region ID 1003, and the coordinate information 1004 illustrated in FIG. 10A can be correctly specified. That is, in step S1103, when adding the calculated pixel coordinates to the work model information, even if the pixel coordinates are added to a non-corresponding region ID, or even if the pixel coordinates calculated for a plurality of region IDs are added, by selecting the matching work model in S1105, the calculated pixel coordinate value of the region can be added to the correct work ID 1001. The work region adjustment unit 215 stores the calculated pixel coordinates for the region ID of the work model information 235. The work model selection unit 222 selects a reference operation model included in the work model generated from the reference image that matches the divided work determination operation model, leaves pixel coordinates for the region ID corresponding to the selected reference operation model, and deletes the pixel coordinates for other region IDs.

By comparing the operation models by the work model selection unit 222, the work region in the image at the time of determination can be associated with the work region of the reference image, and can be managed as the region of pixel coordinates on the image (two-dimensional) of the work region at the time of determination. If there is no work model that is equal to or greater than the threshold, determination is made that there is no matching work mode.

Next, the work determination unit 223 collates the selected work model with the work flow to determine whether the work is correct. If there is no matching work model in step S1105, it is determined that the work is not performed correctly, and if there is a matching work model, it is determined whether the worker's work is performed correctly (S1106). In this determination, one determination criterion is whether the worker is working in the pixel coordinates 1005 of the region of the work model information 235 in the determination image. In addition, whether the work is performed correctly may be determined by comparing the reference operation model and the operation model on the determination screen. For the entire work, collation is performed with the work flow information 236 and work progress information, and if the work is possible at that time, it is determined that the work is performed correctly, and if it is other work, it is determined that the work is not performed correctly (S1106).

As long as it is determined that the work is correct in the work determination, steps S1105 and S1106 are repeatedly performed by storing the work number in flow that has completed in each work in the progress information storage unit. When it is determined that all pieces of work are correct, the work recognition result is output indicating that there is no deviating operation, and when it is determined that even one work is not correct, the work recognition result is output indicating that there is deviating operation.

As described above, according to the present embodiment, the reference image is used to determine the relative position of the work target and the camera, the two-dimensional work region is designated in the reference image, the template information is used to determine the three-dimensional work region, the relative position of the camera and the work target is obtained again at the time of determination, and the two-dimensional work region in the determination image is determined as pixel coordinates on the basis of the three-dimensional work region determined using the reference image. Since the correctness of the work of the worker is determined by these pixel coordinates, even if the position of the camera, the relative position of the camera and the work target, or the relative position of the camera and the worker changes, it is possible to estimate an appropriate work region on an image.

What is claimed is:

1. A work recognition apparatus that recognizes work of a worker from an image acquired by a camera,
the work recognition apparatus comprising:
an input and output unit that transmits and receives data to and from the camera and an external device;
a processing unit connected to the input and output unit; and
a storage apparatus connected to the processing unit,
wherein the processing unit
acquires a reference image including a work target from the input and output unit,
estimates a first relative position of the work target and the camera from the reference image,
converts a two-dimensional work region for the work target included in the reference image into a three-dimensional work region using template information, and stores the three-dimensional work region in the storage apparatus as work model information,
estimates a second relative position of the work target and the camera in a determination image acquired by the camera,
calculates pixel coordinates indicating a two-dimensional work region in the determination image based on the second relative position and the three-dimensional work region, and
outputs the two-dimensional work region in the determination image indicated by the pixel coordinates that has been calculated, so as to be displayed by an input and output apparatus.

2. The work recognition apparatus according to claim 1, wherein
the processing unit uses a calibration pattern of a calibration captured by the camera to estimate camera parameters, and
uses the camera parameters that has been estimated, to estimate the first relative position and the second relative position.

3. The work recognition apparatus according to claim 2, wherein the storage apparatus stores the template information, the template information including at least a shape of a work region, a size of the work region, and a positional relationship with a reference object of a position of the work as information indicating the work region corresponding to the work target.

4. The work recognition apparatus according to claim 2, wherein the work model information stored in the storage apparatus includes a work ID specifying the work of the worker, a reference operation model indicating an operation model of the worker correspondingly to the work ID, a region ID specifying the work region of the worker, and three-dimensional coordinates of the work region.

5. The work recognition apparatus according to claim 4, wherein
the camera includes a plurality of cameras, and
the storage apparatus stores work flow information including a work number indicating the work in a work flow, a camera ID identifying the camera for capturing the work indicated by the work number, a work ID specifying the work of the work number, and a work number in premise flow indicating the work on which work completion before the work indicated by the work number is performed is premised.

6. The work recognition apparatus according to claim 5, wherein
the processing unit
divides the determination image into pieces of work,
selects a reference operation model included in a work model generated from the reference image that matches a determination operation model of the work that has been divided, and
uses pixel coordinates in the determination image for the reference operation model, which is stored as the work model information, to form the two-dimensional work region of the determination image.

7. The work recognition apparatus according to claim 6, wherein
the processing unit stores the pixel coordinates calculated by the processing unit for the region ID of the work model information,
selects the reference operation model included in the work model generated from the reference image that matches the determination operation model of the work that has been divided, and
leaves the pixel coordinates for the region ID corresponding to the reference operation model that has been selected and deletes the pixel coordinates for other region IDs.

8. A work recognition method of recognizing work of a worker from an image acquired by a camera, the method comprising
causing a processing unit connected to an input and output unit that transmits and receives data to and from an external device
to acquire a reference image including a work target from the input and output unit,
to estimate a first relative position of the work target and the camera from the reference image,
to convert a two-dimensional work region for the work target included in the reference image into a three-dimensional work region using template information and store the three-dimensional work region in a storage apparatus as work model information,
to estimate a second relative position of the work target and the camera in a determination image acquired by the camera,
to calculate pixel coordinates indicating a two-dimensional work region in the determination image based on the second relative position and the three-dimensional work region, and
to output the two-dimensional work region in the determination image indicated by the pixel coordinates that has been calculated, so as to be displayed by an input and output apparatus.
